(19) United States
(12) Patent Application Publication
(10) Pub. No.: US 2007/0130129 A1
(43) Pub. Date: Jun. 7, 2007

(54) System and Method for Image-Based Searching

(76) Inventor: Sunil S. Wagle, Lake Forest, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/567,104

(22) Filed: Dec. 5, 2006

Related U.S. Application Data
(60) Provisional application No. 60/742,642, filed on Dec. 6, 2005.

(51) Int. Cl. G06F 17/30

(52) U.S. Cl. 707/3

(57) ABSTRACT

Disclosed is a system and method for web browsing via an image model. In one embodiment, a preview panel with cascading images exists featuring a plurality of images for a particular business and, below, a plurality of rows of images dedicated to all of the businesses. In the plurality of rows below the preview panel thumbnail images exist for each business and when a user mouses over a thumbnail image, the first row will show a plurality of additional images. The systems and methods allow businesses to build brand awareness and consequently, the invention can also provide for a payment model and results ranking algorithms that are driven by branding considerations. The systems and methods provide for a better search experience by obviating the need for users to click through to a site. The user experience may also be enhanced by utilizing color schemes that convey information to the user.

### CROSS-REFERENCE TO RELATED PATENT APPLICATIONS

This patent application claims the benefit of U.S. Provisional Patent Application No. 60/742,642, filed on Dec. 6, 2005.

### TECHNICAL FIELD

The present invention relates generally to world wide web search and online advertising services on the Internet and, more particularly, to systems and methods for presenting image-based search results.

### BACKGROUND OF THE INVENTION

Traditionally, the preferred method of displaying results from world wide web searches has been to present the results in a textual format (e.g., http://www.yahoo.com (“Yahoo”), http://www.google.com (“Google”). A significant drawback to a text-based presentation of search results is that the user does not receive a graphical image of either a particular search result or of the business' website.

Currently, businesses advertising with Google and Yahoo typically pay for each selection by the user that results in the user being redirected to their website. Since with text-based advertising the user does not examine a visual representation of what they are likely going to see when they are redirected to the website corresponding to the link result, research has shown that a disproportionately high number of users end up leaving the website that they are redirected to within about 10 seconds. This results in a situation where businesses advertising with Google and Yahoo end up paying a large percentage of their online advertising budgets for unqualified leads that never result in a sale.

A further result of the above described scenario is that users may become frustrated with using the search engine as at least one additional click is required to view the link result website and/or the item matching the search criteria. If the user is using a web browser that does not allow for tabbed browsing—as is the case with the majority of those currently in use today—or if they do not desire to open many instances of the web browser on their computer, they will need to click the back button on their browser to return to the search result set in the event that the website that they were redirected to was not what they were looking for. The back and forth nature of navigating to the link result website and back to the search results page can become tiresome for the user. As a result, they may be inclined to terminate their search before ever finding their desired search result. Furthermore, over time they may become so disenchanted with the process that they may abandon using the search engine altogether out of frustration.

Additionally, a text-based presentation of search results does not afford businesses the opportunity to effectively create, with the online consumer, a strong branding identity for their company. Because the search results are presented as text, any branding logos or other branding identifiers—that cannot be conveyed to the user without a graphical image—are not able to be presented to the user as part of the search results. If the user does not end up clicking a particular business' link result then any potential for making an impact on the user is lost. Research has shown that online advertising can be highly effective when the user is presented with an image that can make an impression on the user. With text-based search engines any such impressions on the user suffer by only being able to be presented in a textual format.

### SUMMARY OF THE INVENTION

In view of the foregoing, the present invention provides a system and method for world wide web browsing via an image model rather than a text-based model. In the system and method of the present invention, businesses will be able to advertise using images and text rather than just text. In one embodiment, a search results page displays, in a prominent place (e.g., at the top of the page), a preview panel featuring a plurality of different images (e.g., representing a particular business, government agency, or other entity). The preview panel consists of two rows of images: the second (bottom row) represents the highest (or sponsored) hits (i.e., a ranking of entities who are bidding on the keywords in the search) of the search represented as a one or more images per business hit. The top row of the preview panel is activated by mouse hovering over a bottom row image associated with a website that represents a visual/logical preview of the content of that website. When a user mouses (hovers) over a thumbnail image, the top row will show a plurality of additional images, including a company logo and/or text forming preview cascade images. When the user mouses over another thumbnail, the images in the first row will change to show the images associated with another business. Bottom row images may include the business' logo as well as other thumbnail images of products. The business may also provide text if desired. When an image from the bottom row of the preview panel is selected for a preview, the background color of that image and that of the top row will change to indicate browsing preview ancestry/origin. Below the preview panel, there will be a search results panel which consists of plurality of rows of images dedicated to a subset of the businesses, government agencies, or other entities that resulted in hits for the search. In the plurality of rows that represent lower scoring search hits there will be one or more thumbnail images for each business. Users will have an option to pick a row of lower scoring search hits and upgrade it to the preview panel, therefore extending preview capability to other hits.

The above described systems and methods allow businesses to increase the amount of qualified leads obtained from advertising with the search engine. Rather than merely paying for each click that is redirected to their website, with this model businesses will have the confidence that the redirect that they are paying for is a higher quality lead by virtue of the fact that the user has been presented with image data, as opposed to the less informative textual data as is common with state of the art search engines.

A further advantage of the above systems and methods is that they allow businesses to build a stronger brand awareness among the users of the search engine as the user is presented with an image that can make more of an impression on the user than information presented only in a textual format. Consequently, the systems and methods of this invention can also provide for a payment model and results ranking algorithms that are driven, at least in part, by branding considerations.

Yet another advantage of the above systems and methods is that they provide for a better search experience for the user by obviating much of the need for users to click through to a site just to see a visual of the particular search result item and then have to click the back button to return to the search results page. The user experience will be further enhanced by utilizing color coding schemes in the preview panel and search results that convey the browsing hierarchy as well as additional information to the user.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram of an exemplary computer architecture on which the systems and methods of the invention can be implemented;

FIG. 2 is a schematic diagram showing an exemplary communications network in which the method of the invention can be practiced;

FIG. 3 is a screenshot of the search results of the image-based search engine; and

FIG. 4 is a screenshot of the image-based search engine after the user has moused over one of the thumbnail images.

### DETAILED DESCRIPTION OF THE INVENTION

In the description that follows, the invention is described with reference to acts and symbolic representations of operations that are performed by one or more computing devices, unless indicated otherwise. As such, it will be understood that such acts and operations, which are at times referred to as being computer-executed, include the manipulation by the processing unit of the computing device of electrical signals representing data in a structured form. This manipulation transforms the data or maintains them at locations in the memory system of the computing device, which reconfigures or otherwise alters the operation of the computing device in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that several of the acts and operations described hereinafter may also be implemented in hardware.

Turning to the drawings, wherein like reference numerals refer to like elements, the invention is illustrated as being implemented in a suitable networking environment. The following description is based on illustrated embodiments of the invention and should not be taken as limiting the invention with regard to alternative embodiments that are not explicitly described herein.

I. Exemplary Environment

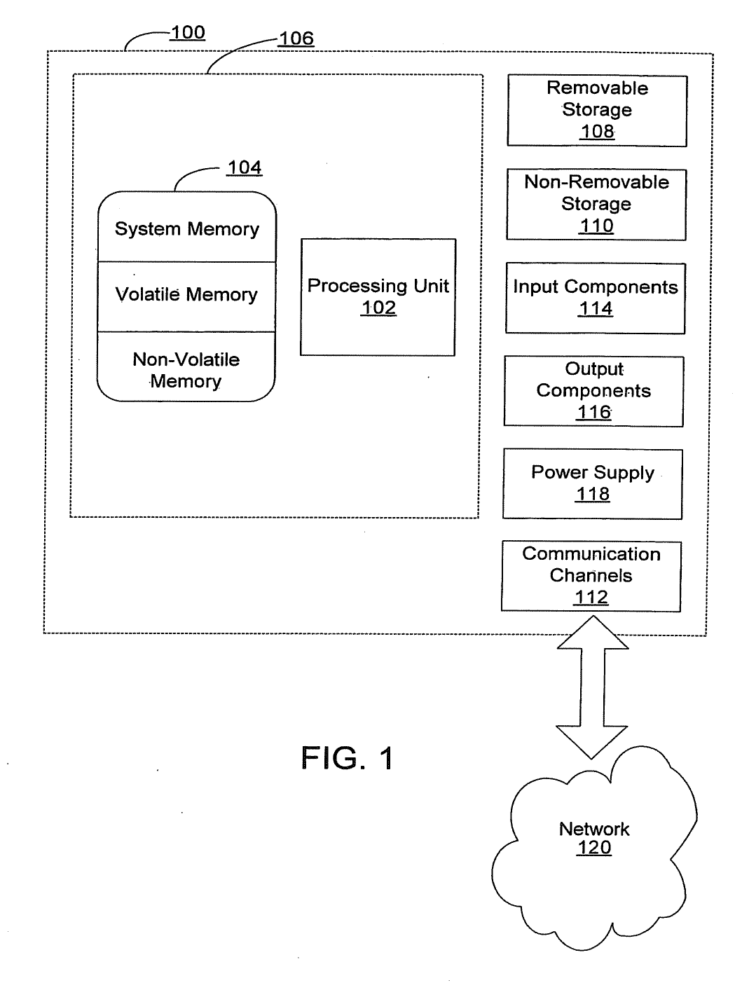

Referring to FIG. 1, the present invention relates to the display of world wide web search results on a computing device. The computing device may have one of many different computer architectures. For descriptive purposes, FIG. 1 shows a schematic diagram of an exemplary architecture usable for these devices. The architecture portrayed is only one example of a suitable environment and is not intended to suggest any limitation as to the scope of use or functionality of the invention. Neither should the computing devices be interpreted as having any dependency or requirement relating to any one or combination of components illustrated in FIG. 1. The invention is operational with numerous other general-purpose or special-purpose computing or communications environments or configurations. Examples of well known computing systems, environments, and configurations suitable for use with the invention include, but are not limited to, mobile telephones, pocket computers, personal computers, servers, multiprocessor systems, microprocessor-based systems, minicomputers, mainframe computers, and distributed computing environments that include any of the above systems or devices.

In its most basic configuration, a computing device 100 typically includes at least one processing unit 102 and memory 104. The memory 104 may be volatile (such as RAM), non-volatile (such as ROM and flash memory), or some combination of the two. This most basic configuration is illustrated in FIG. 1 by the dashed line 106.

Computing device 100 can also contain storage media devices 108 and 110 that may have additional features and functionality. For example, they may include additional storage (removable and non-removable) including, but not limited to, PCMCIA cards, magnetic and optical disks, and magnetic tape. Such additional storage is illustrated in FIG. 1 by removable storage 108 and non-removable storage 110. Computer-storage media include volatile and non-volatile, removable and non-removable media implemented in any method or technology for storage of information such as computer-readable instructions, data structures, program modules, or other data. Memory 104, removable storage 108, and non-removable storage 110 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the computing device.

Computing device 100 can also contain communication channels 112 that allow it to communicate with other devices. Communication channels 112 are examples of communications media. Communications media typically embody computer-readable instructions, data structures, program modules, or other data in a modulated data signal such as a carrier wave or other transport mechanism and include any information-delivery media. The term “modulated data signal” means a signal that has one or more of its characteristics set or changed in such a manner as to encode information in the signal. By way of example, and not limitation, communications media include wired media, such as wired networks and direct-wired connections, and wireless media such as acoustic, radio, infrared, and other wireless media. The term computer-readable media as used herein includes both storage media and communications media. The computing device 100 may also have input components 114 such as a keyboard, mouse, pen, a voice-input component, and a touch-input device. Output components 116 include screen displays, speakers, printers, and rendering modules (often called “adapters”) for driving them. The computing device 100 has a power supply 118. All these components are well known in the art and need not be discussed at length here.

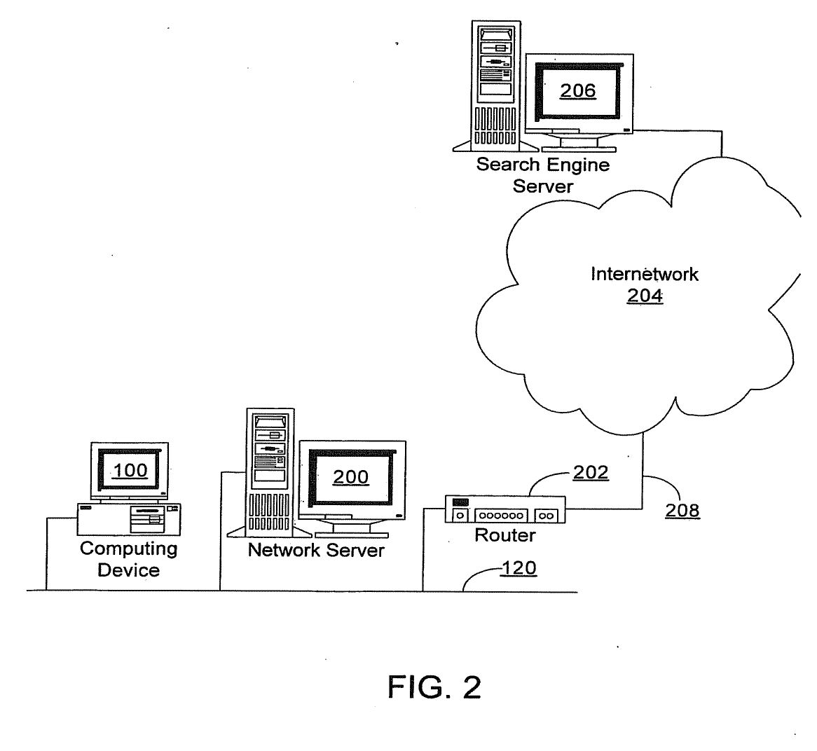

The present invention is directed to systems and methods for displaying world wide web search results on a computing device received over a computer network. Referring to FIG. 2, an exemplary communications network architecture is illustrated. Accompanying a computing device 100 on a local area network (LAN) 120 is a server 200 and a router 202. The router 202 allows the devices on the LAN 120 to communicate over an internetwork 204 to remote computing devices 206. The Internet is one example of an internetwork. In the present example, the server 200 can be a network server which the computing device 100 may access for proxy services to connect to the Internet over the LAN 120 and the remote computing device can be a server which the computing device may access for search results over the Internet 204 or similar wide area network (WAN).

II. Image-based Browsing and Branding

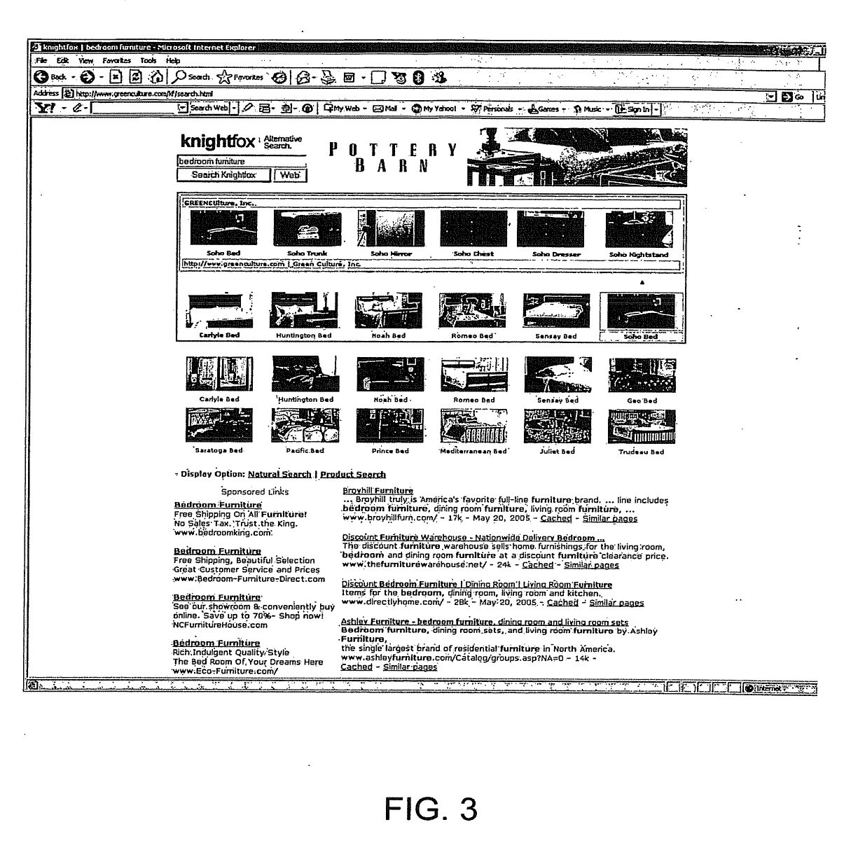

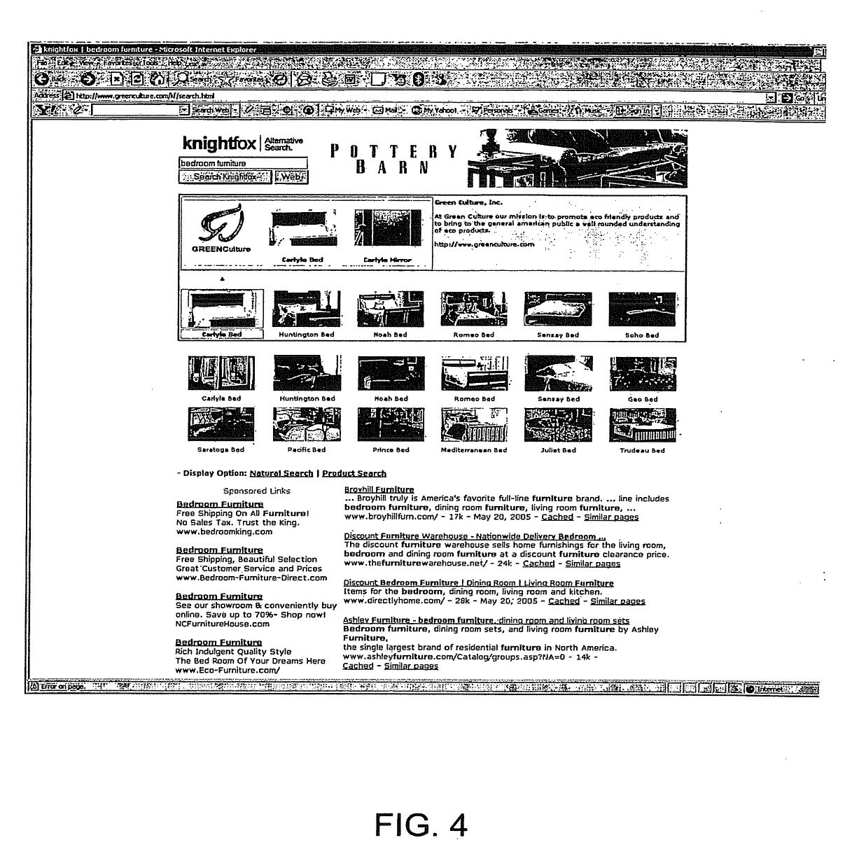

The present invention is directed to systems and methods for displaying world wide web search results on a computing device received over a computer network. With reference to FIGS. 3 and 4, browsing with KnightFox will be done via an image model rather than a text-based model. All advertisers will be able to submit images for use in advertising rather than just text. There will be one preview panel at the top of the page featuring one or more images for an advertiser. This may include their logo as well as other thumbnail images of products and they can also write text if they so desire. Below the preview panel that is dedicated to top paying advertisers, there will be multiple rows of images dedicated to all of the advertisers. The way this works is that in these rows, there will be a mechanism (e.g., checkbox, radiobox, etc.) that may load and display lower scoring rows in the preview panel. In the preview panel when a user mouses over the thumbnail image, the top row will show one or more additional images or some combination of images, company logo and text that represent the logical content of their website without the need to navigate to that website. When the user mouses over another website thumbnail, the images at the very top row will change to show corresponding images of that website (advertiser).

Companies wishing to spend money on the Internet to brand their company currently are not able to do so via Google or Yahoo. With KnightFox, they will be able to do brand advertising even related to a specific category.

Advertisers will get much higher qualified leads. Currently, advertisers pay Google and Yahoo for each click that comes over to their website. However, with text based advertising, users don't get a good idea as to what they are going to get when they click on the ad so 95% end up leaving the site within about 10 seconds. Thus, advertisers are forced to pay 95% of their Google and Yahoo ad budgets for unqualified leads that never end up as a sale. With this model, advertisers will save a lot of money since they will be paying for branding and much higher qualified traffic.

Large and small advertisers will get to brand their companies and clearly show users they type of products and services that they are selling without having to pay a lot of money unnecessarily.

Users will not have to click to a site and then click the back button constantly just to find what they are looking for. Users will be more inclined to buy products as they can easily scan many retailers' products right away all by staying on our same web page. Users will enjoy shopping via image based searching rather than via text based searching. Users can be exposed to many more retailer sites than can be shown via Google or Yahoo.

III. Payment Model and Search Results Ranking

Google and Yahoo currently operate on a pay per click model. Thus, when a user clicks on an advertisement on Google or Yahoo, the advertiser pays an amount of money to Google or Yahoo for the lead. This new model always clearly provides a strong branding opportunity and will allow users to bid on a how much they will pay for branding as well as how much they will pay per click.

Advertisers will bid to get placement in KnightFox. Advertisers will be bid two things: 1) pay per click amount—this is amount of money they will pay when a user clicks on any images displayed by the advertiser; and 2) branding amount—this is the amount of money an advertiser will pay when a user mouses over one of their thumbnail ads which then triggers the preview panel to display other images associated with the advertiser including their logo.

The way the advertisers will be ranked for display on the homepage will be based upon a combination of factors including: click-through rate for the advertisement, branding amount, and pay per click amount.

Advertisers will be ranked and the highest weight will be placed on the branding amount, then the pay per click amount, and then the advertisement's click through rate. Ranking will be done with the highest rank on the top left of the preview panel (and this will be the default page to be shown at the top) so the branding amount will be paid by this advertiser. The second position will be just to the right of the first position, and so on, to the last position in the second row of the preview panel. The next position will be on the third row of the actual page and so on.

The advertiser in position number 1 will pay for the branding amount each time the ad shows up. Then, if a browser mouses over one of the images in the preview panel and clicks on it, the advertiser will pay only once for that click per page visit/session. The total amount the advertiser will pay is calculated by taking the branding amount which they will pay and then adding the pay per click amount less the branding amount which they just paid. Thus, if the branding amount is set to $0.15 and the pay per click amount is $0.50, then if a browser clicks on an image in the preview panel, the advertiser will pay the branding amount of $0.15 plus ($0.50 less $0.15=$0.35), so they will pay a total of $0.50. Typically, the payment will not be less than the branding amount. Thus, if the branding amount is $1.00 and the pay per click is $0.50, the advertiser will pay $1.00 for the click.

In the event a browser just hovers over the thumbnail and the preview panel changes at the top, then the advertiser will pay the branding amount even though the user just mouses over and does not click on any of the thumbnail images in the preview panel.

Different search keywords could have different ads that can be bid on, configured with different images and then displayed specifically for that keyword.

Currently, Google and Yahoo list advertisers in different ways but the bottom line is that Yahoo lists advertisers by who pays more and Google lists them based upon an algorithm of who pays more combined with a mixture of whoever has a higher click through rate on the ads they are displaying. In KnightFox, we will list advertisers based upon a combination algorithm of whoever has a higher click throughout rate, whoever pays more for the branding component of the bidding as well as the actual pay per click bid amount. Only the top paying advertisers (a combination algorithm as outlined above), will be able to showcase their products in the top line. Other advertisers may not be able to showcase all of their different products.

IV. Color Coding Search Results

Color may be used to train people's minds on how search works. If for example someone types in the name of company one color in the search results can be specified to be highlighted if the search algorithms determine that that result is the actual company of the search. This way, people don't have to read much but rather use color codes to get the actual name of the company. For example, if someone types in the word “FORD”, then one of the results will be Ford's actual website such as www.Ford.com and that will be highlighted in a specific color. The other results will be in a different standard color. Search results may also be highlighted in different colors based upon the domain extensions such as .org, .gov, .com, .net, .edu, etc.

In view of the many possible embodiments to which the principles of this invention may be applied, it should be recognized that the embodiments described herein with respect to the drawing figures are meant to be illustrative only and should not be taken as limiting the scope of invention. For example, for performance reasons the method of the present invention may be implemented in hardware, rather than in software. Therefore, the invention as described herein contemplates all such embodiments as may come within the scope of the following claims and equivalents thereof.

What is claimed is:

1. A computer system having a graphical user interface including, a display, a user interface selection device, and a method of providing and selecting from a search result set on the display, comprising the steps of:
(a) retrieving a set of image entries for the search result set including a cascade image entry, the cascade image entry having a specified default command and a set of cascade image items associated therewith;
(b) displaying the search result set on the display comprising the set of image entries;
(c) receiving an image entry selection signal indicative of the user interface selection device pointing at the cascade image entry on the display, and, in response to the selection signal, displaying the set of cascade image items associated with the cascade image entry; and
(d) receiving an execution signal indicative of a user selecting the cascade image entry, and in response to the execution signal, performing the specified default command.

2. The computer system of claim 1, wherein the set of cascade image items comprises a branding image item.

3. The computer system of claim 1, the method of providing and selecting from the search result set on the display further comprising the step of timing an interval between a first receiving the image entry selection signal indicative of the user interface selection device pointing at the cascade image entry on the display and a second receiving the image entry selection signal indicative of the user interface selection device pointing at the cascade image entry on the display.

4. The computer system of claim 3, wherein a cost is computed based on the timing an interval between a first receiving the image entry selection signal indicative of the user interface selection device pointing at the cascade image entry on the display and a second receiving the image entry selection signal indicative of the user interface selection device pointing at the cascade image entry on the display.

5. A method in a computer system, having a user interface selection device, for displaying on a display device a search result set, comprising the steps of:
(a) retrieving a set of image entries for the search result set including a cascade image entry, the cascade image entry having a specified default command and a set of cascade image items associated therewith;
(b) displaying the search result set on the display comprising the set of image entries;
(c) receiving an image entry selection signal indicative of the user interface selection device pointing at the cascade image entry on the display, and, in response to the selection signal, displaying the set of cascade image items associated with the cascade image entry; and
(d) receiving an execution signal indicative of a user selecting the cascade image entry, and in response to the execution signal, performing the specified default command.

6. The method of claim 5, wherein the set of cascade image items comprises a branding image item.

7. The method of claim 5, further comprising the step of timing an interval between a first receiving the image entry selection signal indicative of the user interface selection device pointing at the cascade image entry on the display and a second receiving the image entry selection signal indicative of the user interface selection device pointing at the cascade image entry on the display.

8. The method of claim 7, wherein a cost is computed based on the timing an interval between a first receiving the image entry selection signal indicative of the user interface selection device pointing at the cascade image entry on the display and a second receiving the image entry selection signal indicative of the user interface selection device pointing at the cascade image entry on the display.

9. A computer-readable medium having computer-executable instructions for performing a method in a computer system, having a user interface selection device, for displaying on a display device a search result set, comprising the steps of:
(a) retrieving a set of image entries for the search result set including a cascade image entry, the cascade image entry having a specified default command and a set of cascade image items associated therewith;
(b) displaying the search result set on the display comprising the set of image entries;
(c) receiving an image entry selection signal indicative of the user interface selection device pointing at the cascade image entry on the display, and, in response to the selection signal, displaying the set of cascade image items associated with the cascade image entry; and
(d) receiving an execution signal indicative of a user selecting the cascade image entry, and in response to the execution signal, performing the specified default command.

10. The computer-readable medium of claim 9, wherein the set of cascade image items comprises a branding image item.

11. The computer-readable medium of claim 9 having further computer-executable instructions for performing the step of timing an interval between a first receiving the image entry selection signal indicative of the user interface selection device pointing at the cascade image entry on the display and a second receiving the image entry selection signal indicative of the user interface selection device pointing at the cascade image entry on the display.

12. The computer-readable medium of claim 11 having further computer-executable instructions for performing the step of computing a cost based on the timing an interval between a first receiving the image entry selection signal indicative of the user interface selection device pointing at the cascade image entry on the display and a second receiving the image entry selection signal indicative of the user interface selection device pointing at the cascade image entry on the display.
